(19) United States
(12) Patent Application Publication
(10) Pub. No.: US 2007/0130250 A1
(43) Pub. Date: Jun. 7, 2007

(54) Catch-Up Streaming

(75) Inventor: Brett Heap, Santa Ana, CA (US)

Correspondence Address: Rutan & Tucker, LLP.;Hani Z. Sayed, 611 ANTON BLVD, SUITE 1400, COSTA MESA, CA, 92626, US

(73) Assignee: FARHEAP SOLUTIONS, INC., Santa Ana, CA (US)

(21) Appl. No.: 11/562,501

(22) Filed: Nov. 22, 2006

Related U.S. Application Data
(60) Provisional application No. 60/739,284, filed on Nov. 23, 2005.

(51) Int. Cl. G06F 15/16

(52) U.S. Cl. 709/203

(57) ABSTRACT

A system and a method for catch-up streaming of data to an end user. The system utilizes a rapid, high content transmission of streaming data which may be easily de-compressed and viewed by the end user almost instantaneously from the time of selection of that data. The high content, rapid content is sent upfront to the end user such that the lag and/or delay time from onset of data retrieval may be eliminated. The system then transmits the remaining data from the streaming data at normal transfer speeds after the large, high content rapid transmission has been completed allowing for the continuous data stream transmission and eliminating un-satisfactory reviewing of the transmitted data to the end user.

### PRIORITY CLAIM

This utility patent claims priority to the earlier filed provisional patent application entitled: Catch-Up Streaming having a Ser. No. of 60/739,284 and filed on Nov. 28, 2005.

### FIELD OF THE INVENTION

The field of the invention is for computer network downloading and the transfer of online information. More specifically, the present invention relates to a new system for catch-up streaming of information from online sources.

### BACKGROUND

The technology associated with streaming video or streaming media is a sequence of moving images, sounds, information and the like. Typically streaming data is sent in compressed form over the Internet and displayed to a viewer as it arrives to the user. Streaming media is typically streaming video with sound. Streaming data may encompass a vast plethora of technology and information including algorithms, software, charts, figures and the like. With streaming video, streaming media or streaming data, a Web user does not have to wait for a downloaded file in order to access the data, media and/or video. Instead, the media is sent in a continuous stream and is played as it arrives to the user. Thus the term streaming, which illustrates a continuous exchange of data, media and video.

However, it is necessary for an end user that wishes to view the streaming information to utilize a player, which is a special program that de-compresses the streaming data and sends the de-compressed data, whether it be audio, video or other data, to be displayed to the end user. The player receives the compressed data included in the streaming data, de-compresses the data and sends the information to the appropriate location, including sending the audio data to the speakers and sending the video data to the appropriate video viewing medium. A player can be either an integral part of a browser or downloaded from the software maker's Web site. Major streaming video and streaming media technologies include RealSystem from RealNetwork 200 , Microsoft® Windows Media Technologies and VDO. Microsoft® uses the standard MPEG compression algorithm for video. The other approaches use proprietary algorithms.

Most programs mentioned above use a compression and de-compression program referred to as codec. A codec is a compression algorithm, usually used to reduce the size of a data stream. This program may both compress the information for transmission over the Internet and de-compress the information when received by the end user of the transmission.

Streaming data is usually sent from pre-recorded video files, but can be distributed as part of a live broadcast “feed”. In a live broadcast, the information signal is converted into a compressed digital signal and transmitted from a special Web server that is able to do multicast, which is sending the same file to multiple users at the same time.

However, the problem that exists with this multicasting, is that when multicasting, a plurality of different users are trying to access the same digital signal at the same time, which causes significant internet bandwidth to be used and the use of excessive bandwidth can slow transmission of the signal to the end user. Additionally, another problem that exists is that because so many users may be trying to access the same files at the same time, it may cause a complete collapse of the dedicated special web server that is trying to send the transmission.

Another significant problem that exists with streaming media is that it takes some time for the broadcast signal to be accessed and there is some lag time between the accessing point and the reception of enough data to be displayed to the end user. This means that the end user must wait for enough data to be transmitted, received, de-compressed and displayed before the user may view streaming data.

Thus, there is still a need for a system that provides a method and a system for streaming data to be delivered to an end user without lag and/or delay. Additionally, there is a need for a system that front loads the streaming data which allows for relatively fast, or instant, retrieval of compressed streaming data.

### SUMMARY OF THE INVENTION

The present invention provides a system and a method for catch-up streaming of data to an end user. The contemplated embodiments of the system and method utilize a rapid, high content download of streaming data which may be easily de-compressed and viewed by the end user. The high rapid content is sent upfront to the end user such that the lag and/or delay time from onset of data retrieval may be eliminated. Additionally, the rest of the downloaded streaming data may be sent at normal speed after the large, high content rapid download has been completed, thus allowing the computer systems to work at normal speeds for the remainder of the download, and additionally allowing for the continuous data stream to catch up with the necessary de-compression and data retrieval needs of the individual end user.

To this end, in an exemplary embodiment of the present invention, a method for transmitting streaming data; the method comprising the steps of: providing a user a web browser to request a data clip from a media server on the internet; providing a server that returns the data to the user; launching a media player; storing the streaming data in a buffer; and playing the streaming data after enough of said streaming data is stored in the buffer.

In an exemplary embodiment, the method further comprises the step of: providing an initial streaming data from the server that contains a large amount of data therein.

In an exemplary embodiment, the method further comprises the step of: providing an initial streaming data from the server that contains a large amount of data that may include sufficient data that the streaming data may be viewed instantly.

In an exemplary embodiment, the method further comprises the step of: transmitting an initial large amount of streaming data to a user and further transmitting the remaining amount of streaming data at a normal speed to the end user.

In an exemplary embodiment, the method further comprises the step of: transmitting an initial large amount of streaming data to the user wherein the initial large amount of data may contain approximately between five and twenty minutes of data to the user immediately upon commencement of a download.

In an exemplary embodiment, the method further comprises the step of: allowing a requesting party to immediately access a large amount of data wherein the large amount of data includes a significant portion of requested information and whereby the transmission of data continues after initial transmission at normal access speeds.

In an exemplary embodiment, the method further comprises the step of: allowing the requesting party to access multiple transmission information from multiple servers wherein the requesting party does not encounter lag times between the request of information and reception of such desired information.

To this end, in an exemplary embodiment of the present invention, a system for transmitting streaming data is provided. The system has a computer system including at least a web browser wherein the web browser requests a data information from a media server located at a distant location on the internet. Additionally, the system has a server at a distant location from the web browser that returns the data to a web browser user. Moreover, the system also comprises a media player to display the contents of the information returned to the user and a large initial content streaming data that is stored in a buffer.

In an exemplary embodiment, the system further comprises: an initial streaming data from the server that contains a large amount of data therein.

In an exemplary embodiment, the system further comprises: an initial data stream from the server at a distant location wherein the server sends a large amount of data initially and further wherein the rest of the data is sent at normal transmission speeds.

In an exemplary embodiment, the system further comprises: an initial streaming data from the server that contains a large amount of data that include sufficient data that an end user may access the initial streaming data information immediately.

In an exemplary embodiment, the system further comprises: an initial large amount of streaming data to the end user wherein the initial large amount of data may contain approximately between five and twenty minutes of data to the user immediately upon commencement of a request to a server at a distant location.

In an exemplary embodiment, the system further comprises: allowing for a plurality of requests to multiple servers wherein the requesting party does not encounter lag times between the request of information and reception of such desired information.

In an exemplary embodiment, the system further comprises: the system having no lag-time time between request of information and availability of the requested information.

In an exemplary embodiment, the system further comprises: the system allowing for multiple large data streams of information to be sent to the requesting user wherein lag-time between transmission and availability of the information is eliminated.

Among the many different possibilities contemplated, the system may allow for a significant amount of data to be quickly downloaded by the end user such that broadcast of the data can be displayed almost instantaneously.

Additionally, in an exemplary embodiment, the system may use a codec to quickly de-compress the streaming media for viewing by the end user.

In yet another exemplary embodiment, it is contemplated that the system may utilize a container format which contains one or more streams that are already coded by a codec.

In another exemplary embodiment, it is contemplated that the system will allow an end user to select data to download and after the choice is made by the end user, the system will instantaneously download a large block of data to the end user such that the data can be viewed immediately by the user.

A further exemplary embodiment contemplates that approximately twenty minutes of data or more may be immediately downloaded and de-compressed to the end user for immediate viewing of the data by the end user.

Further, contemplated embodiments of the system may include the continued transmission of the downloaded stream at a normal rate after the transmission of the initial large amount of data has been downloaded, which may allow for seamless display of data to the end user without lags and/or interruptions in the presentation of the data to the user.

Additionally, in an exemplary embodiment, the system may allow the “catch-up” of the stream of data after an initial large amount of data is downloaded, de-compressed and displayed by the user. The “catch-up” would be sufficient time for the data stream being sent at normal speed to download and allow for seamless transmission between the initial large download and the normal incoming data stream transmission.

In operation, streaming data has many advantages. In an exemplary embodiment the streaming data may be used in a plurality of enterprises from downloading videos in an individual's home and/or for use in commercial communications,

In an exemplary embodiment, the realization of cost savings and other benefits make streaming data a real advantage over other means of communication. For example, Business enterprises can boost productivity by streaming training programs including video on demand. Additionally instead of requiring personnel to go to active training, the training can be done on site and at the workstation of an individual.

In another exemplary embodiment, the streaming media may be used for interactive customer service videos which may cut down on expensive customer service calls.

Yet another exemplary embodiment is the use of streaming media that may be used in the home to access videos and other audio/visual content. An individual may be interested in watching movies or downloading a particular sporting event that they wish to watch. Streaming media may allow for easier access to this information rather than having to go to a store to rent or buy the aforementioned movie or sporting event.

Still another exemplary embodiment, is to provide streaming media without the associated lag time between the request for the media and the actual visual/audio display of that media.

Another exemplary embodiment, is to provide streaming media wherein a large amount of data is sent to a requesting party wherein after the initial large data stream is sent to the requesting party, the additional information sent to the requesting party is sent at normal download and data sending speeds.

In still another exemplary embodiment, an improved system and method for the transmission of data is provided wherein the improved system allows for more seamless display of requested data.

Still another exemplary embodiment is provided wherein a system and method for transmission of data allows the receiving party of the transmission data to instantly access and view/hear the information that was requested.

An exemplary embodiment is to provide an improved system and method for the transmission of online data wherein a user is not required to use any special technical programming or software to effectuate the transmission of seamless data over the internet and further wherein the user is unlikely to notice the large stream of data initially sent to them.

However, these advantages are somewhat limited by technological limitations. The lack of synchronization and video components and the lag time in the transmission of the data stream remains a problem, leading to unsatisfying viewer experiences. To remedy this, the present inventions uses a “catch-up” system to reduce or eliminate the unsatisfactory viewing experience.

By using the “catch-up” system that transmits a large amount of information initially to the end user while allowing for a continuous stream to be transmitted thereafter at normal speeds, the quality of the viewing experience is greatly increased and the unsatisfactory viewing experience may be eliminated.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a schematic of the present invention illustrating the catch up streaming system in an exemplary embodiment.

FIG. 2 is a graphical depiction of the invention illustrating the catch up streaming system in an exemplary embodiment.

### DETAILED DESCRIPTION OF THE INVENTION

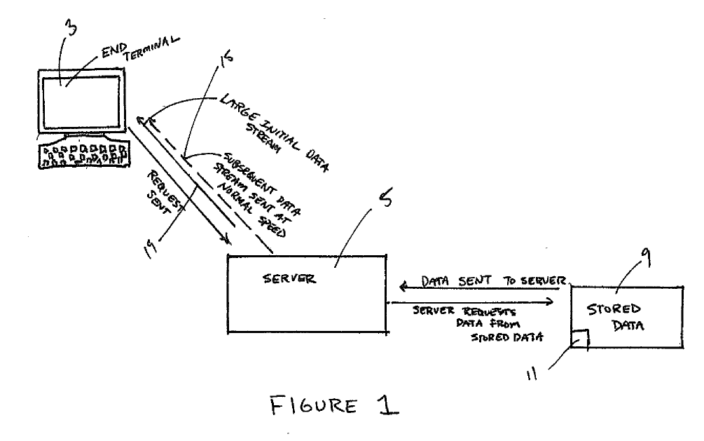

Turning now to the drawings wherein elements are identified by numbers and like elements are identified by like numbers throughout the figures, FIG. 1, for example, illustrates a catch-up streaming system 1 that allows a user at an end terminal 3 to access information from a distant site and obtain that information in real time. Typically, the end user at a terminal 3 will make a request via the server 5 to a server at a distant location 7 for information that the end user desires to see and/or watch. The server at a distant location 7 may have stored data 9 in a memory apparatus 11. Once the server at a distant location 7 is accessed, it may retrieve the information from the memory 11 and send back the stored data 9 either directly to the end terminal 3 or to the server 5 associated with the end terminal 3.

However, typically the data stream sent from the stored data 9 memory 11 is typically sent back to the server 5 or the end terminal 3 in normal data stream 15 speeds which are typically affected by usage, bandwidth, and a host of other normal factors that determine the speed in which the normal data stream 15 is sent back to the server 5 and/or the end terminal 3. Therefore, in normal usage, the end user may request information from a distant location whereby upon return of the normal data stream 15, the end terminal 3 may receive inadequate data to display the information to the end user. Thereby, the end user must wait until enough of the normal data stream 15 has been sent from the stored data 9 to the end terminal 3 and/or server 5. When enough stored data 9 has been received to the end terminal 3 and/or server 5, only then may the information may be displayed at the end terminal 3 to the end user.

The present invention eliminates the delay and wait time between the request for information and the presentation of the stored data to the end terminal 3. In an exemplary embodiment, the system 1 may allow for a large initial data stream 19 to be sent directly from the stored data 9 memory 11 to the end terminal 3 whereby enough stored data information is sent in an initial stream 19 that the end user may be able to immediately access and view the information requested. In another exemplary embodiment, the system may allow for a large initial data stream 19 to be sent directly from the stored data 9 memory 11 to the server 5 whereby the server 5 may immediately transmit the large initial stream 19 of stored data 9 to the end terminal 3 for subsequent viewership of the data to the end user. The large initial stream 19 may contain sufficient information such that the stored data 9 requested by the end user may be viewed immediately instead of waiting for sufficient amount of the data to be transmitted back to the end terminal in a fashion used by normal data transmission streams 15.

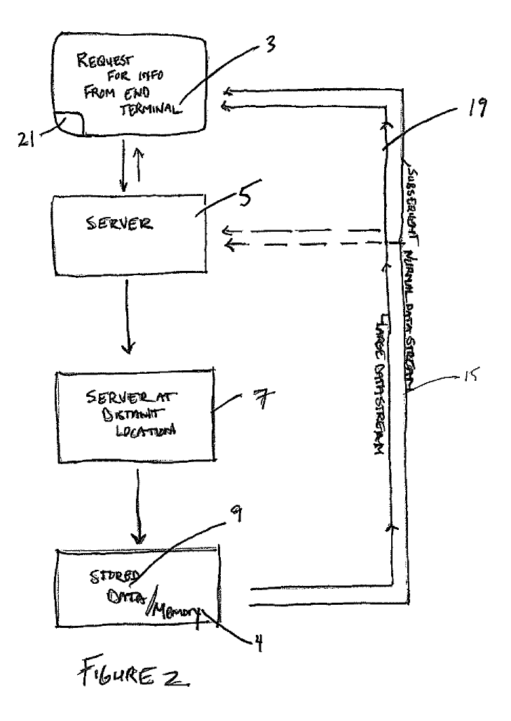

As illustrated in both FIGS. 1 and 2, in an exemplary embodiment of the present invention, the catch-up streaming system 1 may allow for a end user at an end terminal 3 to request information that is routed through a server 5. The server 5 may then request the information from a server at a distant location 7. The information requested may be obtained from stored data 9 contained in a memory bank 11 for retrieval. Additionally, in an exemplary embodiment, the information may be directed back to the end terminal 3 and/or the server 5 very similarly to traditional transmission means. However, in an embodiment of the present invention, a large amount of data is transmitted to the end user via the server 5 whereby the user may immediately access the requested information instead of having to wait for enough information to be transmitted before the user may access the information. Typically, after the information is received by the end terminal 3, the information must be de-compressed in order for the end user to view the requested information. This typically adds to the length of time that the end user must wait to view the requested information. Because a large initial stream of data 19 is sent, the user may not need to wait for enough data to be transmitted, received, de-compressed and displayed because the system only need receive and de-compressed enough of the large initial stream 19 for the information to be viewed by the end terminal, thereby cutting the amount of time necessary for broadcast and receipt of information. Additionally, because a large amount of data 19 is sent from the stored data 9 at a distant location server 7, the server 7 may accommodate a plurality of different users and different end terminals without completely collapsing or experiencing excessive lag time in request and transmission rates.

Similarly, as illustrated in FIGS. 1 and 2, after the initial large data stream 19 is sent to the end user, the rest of the data information that is not sent in the large data stream 19 may be sent in a traditional, normal manner. This subsequent normal data stream 15 may continue immediately after the large data stream 19 has been sent and may buffer the information stream such that the end user may view the requested information without interruption in the data streams enough information is stored in a memory bank 21 contained in the end user terminal 3. In an exemplary embodiment, a plurality of large data streams 19 may be sent concurrently followed by normal data streams 15 for multiple requests of information by the end user.

Thus, specific embodiments and applications of a safety device system have been disclosed. It should be apparent, however, to those skilled in the art that many more modifications besides those already described are possible without departing from the inventive concepts herein. The inventive subject matter, therefore, is not to be restricted except in the spirit of the appended claims. The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The following claims are provided to add additional clarity to this disclosure. What is claimed is:

1. A method for transmitting streaming data; the method comprising the steps of:
providing a user a web browser to request a data clip from a media server on the internet;
providing a server that returns the data to the user;
launching a media player;
storing the streaming data in a buffer; and
playing the streaming data after enough of said streaming data is stored in the buffer.

2. The method of claim 1, wherein the method comprises the additional step of:
providing an initial streaming data from the server that contains a large amount of data therein.

3. The method of claim 1, wherein the method comprises the additional step of:
providing an initial streaming data from the server that contains a large amount of data that may include sufficient data that the streaming data may be viewed instantly.

4. The method of claim 1, wherein the method comprises the additional step of:
transmitting an initial large amount of streaming data to a user and further transmitting the remaining amount of streaming data at a normal speed to the end user.

5. The method of claim 1, wherein the method comprises the additional step of:
transmitting an initial large amount of streaming data to the user wherein the initial large amount of data may contain approximately between five and twenty minutes of data to the user immediately upon commencement of a download.

6. The method of claim 1, wherein the method comprises the additional step of:
allowing a requesting party to immediately access a large amount of data wherein the large amount of data includes a significant portion of requested information and whereby the transmission of data continues after initial transmission at normal access speeds.

7. The method of claim 1, wherein the method comprises the additional step of:
allowing the requesting party to access multiple transmission information from multiple servers wherein the requesting party does not encounter lag times between the request of information and reception of such desired information.

8. A system for transmitting streaming data; the system comprising:
a computer system including at least a web browser wherein the web browser requests a data information from a media server located at a distant location on the internet;
a server at a distant location from the web browser that returns the data to a web browser user;
a media player to display the contents of the information returned to the user; and
a large initial content streaming data that is stored in a buffer.

9. The system of claim 8, further comprising:
an initial streaming data from the server that contains a large amount of data therein.

10. The system of claim 8, further comprising:
an initial data stream from the server at a distant location wherein the server sends a large amount of data initially and further wherein the rest of the data is sent at normal transmission speeds.

11. The system of claim 8 further comprising:
an initial streaming data from the server that contains a large amount of data that include sufficient data that an end user may access the initial streaming data information immediately.

12. The system of claim 8 further comprising:
an initial large amount of streaming data to the end user wherein the initial large amount of data may contain approximately between five and twenty minutes of data to the user immediately upon commencement of a request to a server at a distant location.

13. The system of claim 8 further comprising:
allowing for a plurality of requests to multiple servers wherein the requesting party does not encounter lag times between the request of information and reception of such desired information.

14. The system of claim 8 further comprising:
the system having no lag-time between request of information and availability of the requested information.

15. The system of claim 8 further comprising:
the system allowing for multiple large data streams of information to be sent to the requesting user wherein lag-time between transmission and availability of the information is eliminated.
